(19) United States
(12) Patent Application Publication
(10) Pub. No.: US 2002/0026717 A1
(43) Pub. Date: Mar. 7, 2002

(54) Electrical power tool with a rotatable working tool

(76) Inventor: Markus Hartmann, Mauerstetten (DE)

Correspondence Address: DAVID TOREN, ESQ., SIDLEY, AUSTIN, BROWN & WOOD, LLP, 875 THIRD AVE, NEW YORK, NY, 10022, US

(21) Appl. No.: 09/928,773

(22) Filed: Aug. 13, 2001

(30) Foreign Application Priority Data
Aug. 17, 2000 (DE) 100 40 332.8

(51) Int. Cl. B23D 45/16

(52) U.S. Cl. 30/388

(57) ABSTRACT

An electrical power tool including a motor-driven shaft (2) for supporting a circular working tool (3), a switch (7) for turning a shaft driving motor on and off, a device (10) for braking the shaft (2), a safety element (8) having a safety position, in which it actuates the braking device (10) and prevents turning of the shaft driving motor on, and a release position, in which it deactuates the braking device (10) and provides for turning of the shaft driving motor on, and a locking mechanism (21) having two positions, in which the safety element (8) respectively, is retained in its safety position and occupies its release position.

### BACKGROUND OF THE INVENTION

1. Field of the Invention

The present invention relates to an electric power tool including a motor-driven shaft for supporting a circular working tool, a locking device for securing the working tool on the shaft, switch for turning a shaft driving motor on an off a braking device for braking the shaft or the walking tool, a safety element having a safety position, in which it actuates the braking device and prevents turning of the shaft driving motor on, and a release position, in which it deactuates the braking device and provides for turning of the shaft driving motor on, with the braking device being mechanically connected with the safety element.

2. Description of the Prior Art

An electric power tool of the above-described type includes a coupling connecting the switch with the safety element for preventing an inadvertent actuation of the tool. The braking device serves for rapid braking of the working tool (working shaft) and/or the motor. The braking device is connected with the safety element, e.g., by a linkage. The braking device occupies a non-braking or release position in the release position of the safety element, which makes the turning of the motor on possible. When the safety element is in its safety position, the turning of the motor on cannot be effected, and the braking device is in its braking position.

The above-described electric power tool is disclosed, e.g., in German Publication DE-A1-40 07 030. In the disclosed electric power tool, the braking device, which is mechanically connected with the safety element, is used for braking the working tool. The safety element has safety and release positions. In the release position of the safety element, the electric power tool motor can be turned on, and the braking device is deactuated, i.e., it occupies its non-braking position. In the safety position of the safety element, switching of the motor on is not possible, and the braking device is actuated, i.e., it occupies its braking position. The braking device includes a braking member rotable about a rotational axis extending parallel to the power tool shaft. The braking member acts on braking drum mounted on the shaft. As a result of frictional forces, which act between the braking member and the braking drum, the motor and the working tool are braked. The actuation of the braking device is effected with an actuation member formed by a linkage including a plurality of articulated elements.

A drawback of the known electric power tool consists in that an inadvertent switching of the driving motor on is still possible with the tool locking device still occupying its unlocking position.

An object of the invention is to provide means that would reliably prevent an inadvertent switching of the power tool motor on and that could be reliably and simply actuated.

Another object of the invention is to provide means that would reliably prevent the switching of the power tool motor on and that could be economically manufactured.

### SUMMARY OF THE INVENTION

These and other objects of the present invention, which will become apparent hereinafter, are achieved by providing a locking mechanism displaceable between a release position, in which the safety element is retained in its safety position, and a locking position in which the safety element is in its release position.

The use of a locking mechanism for retaining the safety element in its safety or release positions permits to reliably prevent an erroneous manipulation of the safety element and the switch by a user during the operation of the braking device of the power tool. The operation is predetermined by the power tool itself. When the safety element in its safety position, the turning of the motor on is impossible. With the tool locking device in its release position, the safety element becomes locked in its safety position by the locking mechanism. Only when the tool locking device occupies its locking position, the safety element is returned into its release position.

Preferably, both the locking mechanism and the locking device, which secures the working tool on the shaft, are actuated by a single locking lever, which insures simple and convenient operation by integration of two functions which can be performed with a single actuation element, the locking lever. A connection between the locking mechanism and the working tool locking device is provided in a simple manner with the use of a single actuation lever, the function of the release mechanism remains invisible to the user, and the use of a single lever facilitate handling of the power tool.

Advantageously, the locking mechanism has a locking member engageable in a groove provided in the braking device. The simple and cost-effective, from the manufacturing point of view, construction of the locking mechanism according to the present invention insures its advantageous application. However, dependent on particular features of an electrical power tool and its operation, other constructions of the locking mechanism can be contemplated.

Advantageously, the locking member is pivotally supported on a bolt which secures the locking member to the housing or housing component and provides for a pivotal movement of the locking member into the groove formed in the braking device.

Advantageously, the locking lever is provided with a control cam surface which serves for guiding the locking member, insuring stable control of the locking mechanism. The cam surface is so formed that it insures a positive guiding of the locking member. The use of a cam surface permitted to eliminate a spring for forcing the locking member out of the groove of the braking device. Also, the cam surface permitted to increase the durability of the entire structure. The cam surface advantageously is provided in the pivot region of the locking lever.

Further, advantageously, the cam surface is provided with a section that fixes the locking member in the locking position of the lever. Thereby, an undesired displacement of the locking member from its locking position into its release position is prevented. When the locking member is displaced from its locking position into its release position, the user becomes aware that the locking device, which secures the working tool on the shaft, is in its release position.

Advantageously, the locking mechanism is made of a plastic material, which insures its cost-effective manufacturing.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS:

The drawings show:

FIG. 1 a perspective view of an electrical power tool according to the present;

FIG. 2 a perspective view of a braking device for use with an inventive power tool;

FIG. 3 a side view of a locking mechanism, a braking device, and a locking lever in a locking position; and

FIG. 4 a side view of a locking mechanism, a braking device, and a locking lever in a release position.

### DETAILED DESCRIPTION OF THE PREFERRED EMBODIMENT

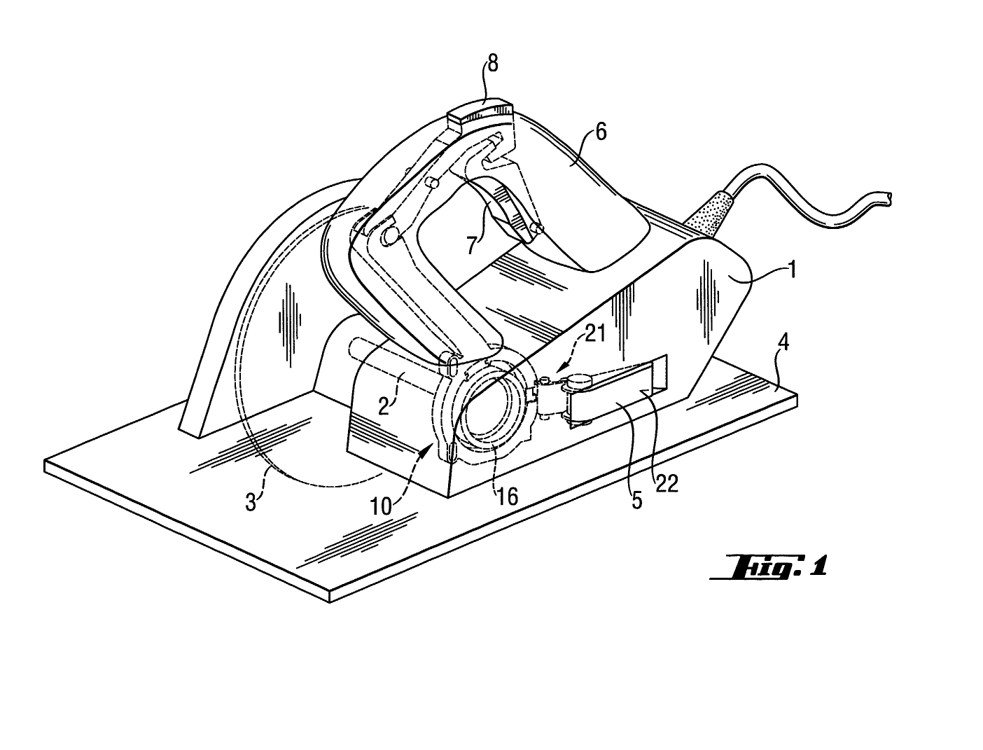

An electrical power tool according to the present invention and, specifically, a circular saw, which is shown in FIG. 1, includes a housing 1 and a motor-driven shaft 2. The shaft 2 is releasably connected with a working tool 3 by a locking device (not shown). For actuating the locking device, a locking lever 5 is provided. The locking lever 5 is pivotally supported on the housing 1 for pivotal movement between locking and release positions. In the locking position of the locking lever 5, the working tool 3 is fixedly secured on the shaft 2 for joint rotation therewith. In the release position of the locking lever 5, the working tool 3 is not secured to the shaft 2 and can be easily removed.

A bearing plate 4 supports the electrical power tool for displacement along a surface. The working tool 3 extends through the bearing plate 4. The housing 1 is provided with a handle 6 with a, provided thereon, switch 7 for turning a driving motor (not shown) on and off, and a safety element 8 having safety and release positions.

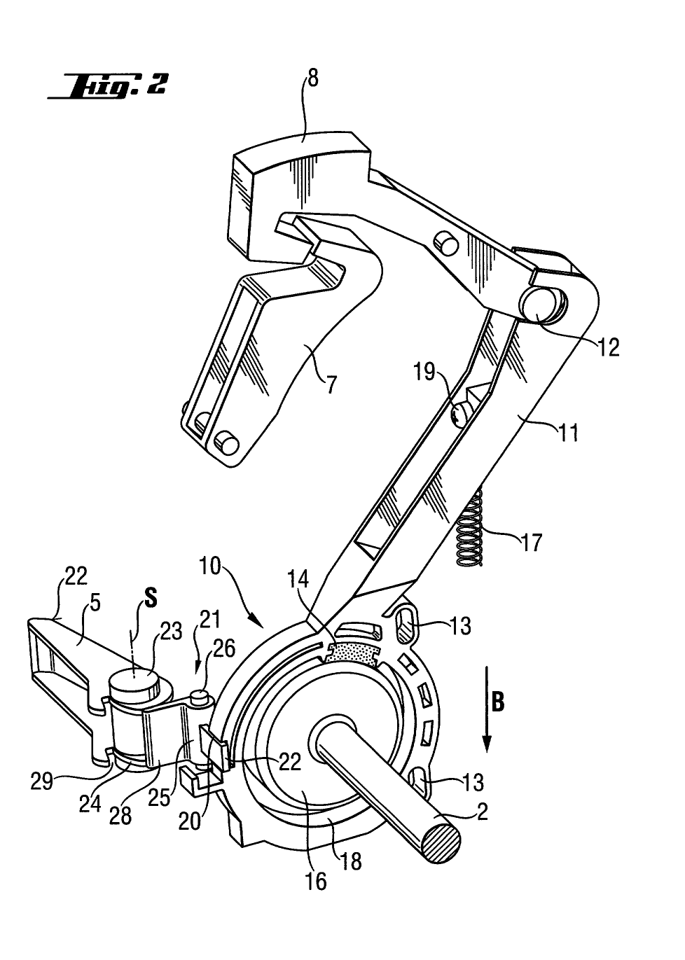

FIG. 2 shows a braking device 10 which is mechanically connected with the safety element 8, the shaft 2, and the switch 7. The safety element 8, and the switch 7 are connected with the braking device 10 by an actuation member 11 which forms an integral part of the braking device 10. A force acting on the safety element 8 is transmitted to the braking device via a plurality of articulated joints 12, causing a movement in a direction opposite to that indicated with arrow B. The braking device 10 has a plurality of openings 13 into which respective guide elements (not shown), which are secured on the housing 1, engage.

The braking device 10 has a braking member 14 which, upon movement in the direction indicated by arrow B or in the braking direction, contacts a braking drum 16 which is secured on the shaft 2. The resulting friction leads to braking of the rotational movement of the shaft 2. In the safety position of the safety element 8 as shown in FIG. 2, a spring 17, which is secured at one of its ends to the actuation member 11 with a screw 19 and is secured at it opposite end to the housing 1, pulls the actuation member 11 and, thereby the braking member 14 against the braking drum 16. Upon displacement of the safety element 8 into its release position, the braking member 14 is displaced against the biasing force of the spring 17 in the direction opposite the braking direction, i.e., in the direction opposite to that indicated with arrow B. In the release position of the braking device 10, the shaft 2 is not constrained and becomes freely rotatable. The shaft 2, together with the braking drum 16, is received in recess 18 provided in the braking device 10. In the region of the recess 18 and of the shaft 2, a groove 20, which extends substantially parallel to the shaft 20, is provided on the braking device 10.

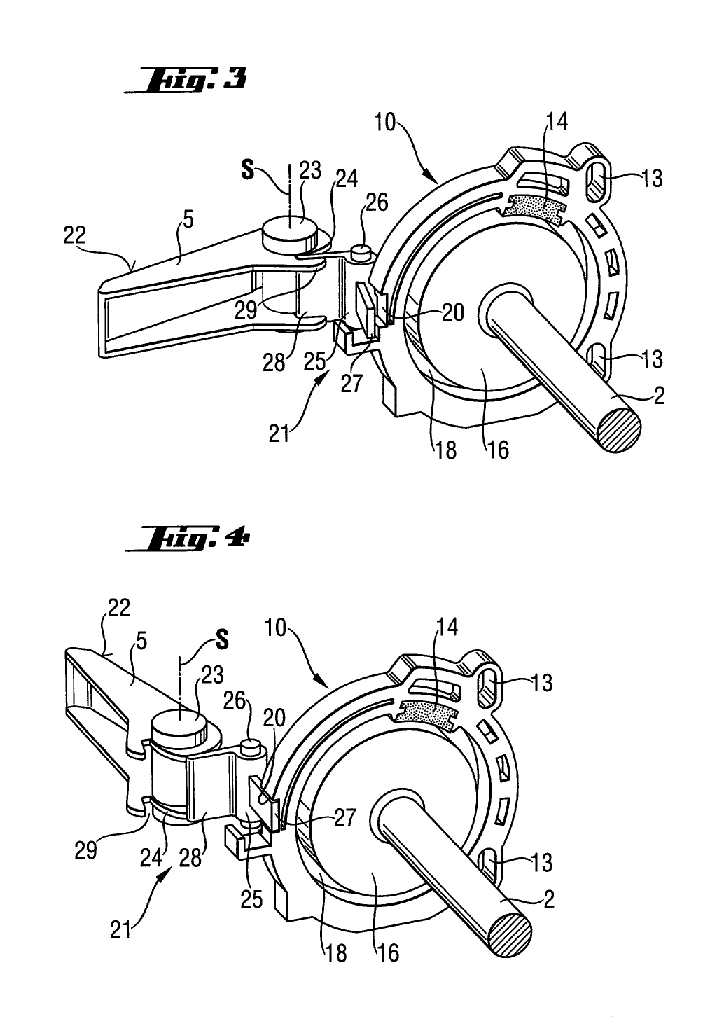

FIGS. 3-4 show a portion of the braking device 10 with the groove 20, the locking lever 5, the shaft 2, and the locking mechanism generally designated with a reference numeral 21.

The locking lever 5 has, at one of its end, a holding portion 22 and at an opposite end, a cylindrical guide member 23. The guide member 23 is received in two bores provided in the housing 1 for pivotal movement about a pivot axis S. The locking mechanism 21 has a locking member 25 which engages two cams 24 which extend around the guide member 23 transverse to the pivot axis S. The locking member 25 is pivotally connected with the housing 1 by a bolt 26 that extends parallel to the pivotal axis S. The locking member 25 has a locking arm 27 and a control arm 28 extending transverse to the locking arm 27. The locking arm 27 is displaced, upon a pivotal movement of the locking lever 5 between its locking position which is shown in FIG. 3 and which corresponds to the locking position of the tool locking device, and its release position which is shown in FIG. 4 and which corresponds to the unlocking position of the tool locking device.

In its release position, the locking arm 27 extends into groove 20. The locking arm 27 occupies this position when the safety element 8 is in the safety position. The formlocking engagement of the locking arm 27 in the groove 20 retains the braking device 10 in its braking position. Upon pivotal movement of the locking lever 5 into its locking position, the locking arm 27 moves out of the groove 20, and the interlocking position between the braking device 10 and the locking element 25 or housing 1 is broken. As the safety element 8 is connected rigidly with the braking device 10 by the actuation member 11, the release of the braking device 10 results in the release of the safety element 8, so that the switch 7 becomes operable.

In order to prevent an inadvertent displacement of the locking lever 5 from its locking position shown in FIG. 3 into its release position shown in FIG. 4, the cam 24 has a stop section 29.

The locking mechanism 21 is formed of a plastic material by an injection molding process.

Though the present invention was shown and described with references to the preferred embodiment, such are merely illustrative of the present invention and are not to be construed as a limitation thereof, and various modifications of the present invention will be apparent to those skilled in the art. It is therefore, not intended that the present invention be limited to the disclosed embodiment or details thereof, and the present invention includes all variations and/or alternative embodiments within the spirit and scope of the present invention as defined by the appended claims.

What is claimed is:

1. An electrical power tool, comprising a motor-driven shaft (2) for supporting a circular working tool (3); a switch (7) for turning a shaft driving motor on and off; a device (10) for braking the shaft (2); a safety element (8) having a safety position, in which it actuates the braking device (10) and prevents turning of the shaft driving motor on, and a release position, in which it deactuates the braking device (10) and provides for turning of the shaft driving motor on; and a locking mechanism (21) displaceable between a locking position thereof which corresponds to an unlocking position of locking means that secure the working tool (3) on the shaft (2) and in which the safety element (8) is retained in the safety position thereof, and a release position thereof in which the locking means is in its locking position and the safety element (8) occupies the release position thereof.

2. An electric power tool according to claim 1, further comprising a locking lever (5) for actuating both the locking means and the locking mechanism (21).

3. An electric power tool according to claim 2, wherein the braking device (10) has a groove (20), and the locking mechanism (21) has a locking member (25) engaging in the groove (20) of the braking device (10) in the braking position of the braking device.

4. An electric power tool according to claim 3, further comprising a bolt (26) for pivotally supporting the locking member (25).

5. An electric power tool according to claim 3, wherein the locking lever (5) has cam means (24) for guiding the locking member (25) between engaging and disengaging positions thereof.

6. An electric power tool according to claim 5, wherein the cam (24) has a section for stopping the locking member (25) in the engaging position thereof.

7. An electric power tool according to claim 1, wherein the locking mechanism is formed of a plastic material.

8. An electric power tool according to claim 1, further comprising means (11) for mechanically connecting the safety element (8) with the braking device (10).
